(19) United States
(12) Patent Application Publication
(10) Pub. No.: US 2019/0133156 A1
(43) Pub. Date: May 9, 2019

(54) POWDERY BREADER, AND BREADER MIX, COATING MATERIAL, AND DEEP-FRIED (-LIKE) FOOD PRODUCT USING POWDERY BREADER, AND PRODUCTION METHODS THEREFOR

(71) Applicant: J-OIL MILLS, INC., Tokyo (JP)

(72) Inventors: Junpei KUBOTA, Tokyo (JP); Isao KOBAYASHI, Tokyo (JP); Siripat JANARAM, Bangkok (TH); Chonpapat APIROMSAMER, Bangkok (TH); Maytinee BORVONPARADORN, Bangkok (TH)

(21) Appl. No.: 16/096,578

(22) PCT Filed: Apr. 19, 2017
(86) PCT No.: PCT/JP2017/015728

§ 371 Date: Oct. 25, 2018

(30) Foreign Application Priority Data
Apr. 28, 2016 (JP) 2016-091707

(51) Int. Cl. A23L 5/10; A23L 7/157; A21D 10/04; A23L 29/212

(52) U.S. Cl. CPC A23L 5/11; A23L 7/157; A23V 2002/00; A23L 29/212; A21D 10/04

(57) ABSTRACT

Provided is a powdery breader including a starch at a proportion of 75% by mass or more and 100% by mass or less, in which the powdery breader includes, as the starch, a lowered molecular weight starch having an amylose content of 5% by mass or more and a peak molecular weight of 3×10³ or more and 5×10⁴ or less, at a proportion of 3% by mass or more and 45% by mass or less with respect to the total amount of the powdery breader, in which a content of oversized particles retained on a sieve with openings of 0.1 mm in the powdery breader is 20% by mass or more and 100% by mass or less, and in which the powdery breader is used for one or two or more deep-fried (-like) food products selected from the group consisting of hot showcase storage, room temperature storage, chilled storage, frozen storage, and microwave cooking.

### TECHNICAL FIELD

The present invention relates to a powdery breader, and a breader mix, a coating material, and a deep-fried (-like) food product, all using this powdery breader, as well as methods for producing these.

### BACKGROUND ART

Regarding a technology for attempting an enhancement in the mouthfeel of deep-fried food products such as a karaage, the technology described in Patent Document 1 (Japanese Patent Laid-Open No. 2002-253156) may be mentioned. In the same patent document, a cracker powder analogue including a particulate material produced using grains as a main raw material, the particulate material having the specific gravity and the particle size in particular ranges, is described. According to the patent document, it is considered that when such a cracker powder analogue is used, the cracker powder analogue is close to cracker powder and can further enhance a crispy feeling, which is an advantage of cracker powder.

Patent Document 2 (International Publication No. WO 2012/105673) describes a technology of combining a water-retaining agent used for a water retention treatment of fillings, with a particular thickener in a production process for a frozen deep-fried food for warmer storage, which is to be eaten after being deep-fried in oil, frozen, deep-fried in oil again, and then kept warm in a warmer case. According to such a method, it is considered that even in a case in which a frozen deep-fried food is deep-fried in oil again and kept warm in a warmer case after being frozen and stored, deterioration of the juicy feelings of fillings and hardening of the coating to become hard to bite can be suppressed, and crispness of the coating can be sustained.

In Patent Document 3 (Japanese Patent Laid-Open No. 2013-146250), it is described that a breader mix for deep-fried food having a crispy mouthfeel, the mouthfeel being maintained for a long time period and being not likely to be deteriorated by freezing and thawing, is obtained by incorporating glutinous rice powder that has been subjected to a moist-heat treatment under particular conditions, into a breader mix.

Furthermore, regarding a food product material using starch, there is a food product material described in Patent Document 4 (International Publication No. WO 2014/132534).

### RELATED DOCUMENT

### Patent Document

[Patent Document 1] Japanese Patent Laid-Open No. 2002-253156

[Patent Document 2] International Publication No. WO 2012/105673

[Patent Document 3] Japanese Patent Laid-Open No. 2013-146250

[Patent Document 4] International Publication No. WO 2014/132534

### SUMMARY OF THE INVENTION

### Technical Problem

However, even if the technologies described in Patent Documents 1 to 3 described above are used, there is still room for improvements from the viewpoint of providing a deep-fried (-like) food product which, when subjected to hot showcase storage, room temperature storage, chilled storage, frozen storage, or microwave cooking, has reduced stringing of the coating, maintains a crisp light mouthfeel, and has suppressed deterioration of the mouthfeel of fillings.

### Solution to Problem

According to the invention, there is provided:

a powdery breader including a starch at a proportion of 75% by mass or more and 100% by mass or less,

in which the powdery breader includes, as the starch, a lowered molecular weight starch having an amylose content of 5% by mass or more and having a peak molecular weight of 3×10³ or more and 5×10⁴ or less, at a proportion of 3% by mass or more and 45% by mass or less with respect to the total amount of the powdery breader,

in which a content of oversized particles retained on a sieve with openings of 0.1 mm in the powdery breader is 20% by mass or more and 100% by mass or less, and

in which the powdery breader is used for one or two or more deep-fried (-like) food products selected from the group consisting of food products for hot showcase storage, room temperature storage, chilled storage, frozen storage, and microwave cooking.

Furthermore, according to the invention, a breader mix including the powdery breader according to the present invention is provided.

Furthermore, according to the invention, a coating material including the breader mix according to the present invention is provided.

Furthermore, according to the invention, one or two or more deep-fried (-like) food products including the coating material according to the present invention, wherein the deep-fried (-like) food products are selected from the group consisting of food products for hot showcase storage, room temperature storage, chilled storage, frozen storage, and microwave cooking.

Furthermore, according to the invention, there is provided:

a method for producing a powdery breader used for one or two or more deep-fried (-like) food products selected from the group consisting of food products for hot showcase storage, room temperature storage, chilled storage, frozen storage, and microwave cooking,

the method including:

subjecting a starch having an amylose content of 5% by mass or more to a molecular weight reduction treatment and obtaining a lowered molecular weight starch having a peak molecular weight of 3×10³ or more and 5×10⁴ or less;

incorporating the lowered molecular weight starch into a raw material at a proportion of 3% by mass or more and 45% by mass or less, and subjecting the raw material in which the sum of the content the lowered molecular weight starch and a content of starch other than the lowered molecular weight starch in the raw material is 75% by mass or more, to a gelatinization treatment; and

screening a partially or fully gelatinized product obtained by the gelatinization treatment so that the content of oversized particles retained on a sieve with openings of 0.1 mm is adjusted to 20% by mass or more and 100% by mass or less.

Furthermore, according to the invention, there is provided:

a method for producing one or two or more deep-fried (-like) food products selected from the group consisting of food products for hot showcase storage, room temperature storage, chilled storage, frozen storage, and microwave cooking,

the method including:

obtaining the powdery breader by the method for producing a powdery breader according to the present invention;

preparing a breader mix including the powdery breader;

attaching the breader mix to an outer side of fillings; and

heating and cooking the fillings having the breader mix attached thereto, and thereby obtaining deep-fried (-like) food products.

Meanwhile, embodiments resulting from converting arbitrary combinations of these various configurations or expressions of the present invention between methods or processes, apparatuses, usage, and the like are also effective as embodiments of the present invention.

For example, according to the invention, use of the powdery breader according to the invention or a breader mix including such a powdery breader in a coating material is provided.

According to the invention, use of the powdery breader according to the invention or a breader mix including such a powdery breader in one or two or more deep-fried (-like) food products selected from the group consisting of food products for hot showcase storage, room temperature storage, chilled storage, frozen storage, and microwave cooking, for example, use in karaages, pork cutlets, or deep-fried prawns, is provided.

Furthermore, according to the invention, use of the powdery breader according to the invention or a breader mix including such a powdery breader for the production of a coating material, is provided.

Furthermore, according to the invention, use of the powdery breader according to the invention or a breader mix including such a powdery breader for the production of one or two or more deep-fried (-like) food products selected from the group consisting of food products for hot showcase storage, room temperature storage, chilled storage, frozen storage, and microwave cooking, for example, use for the production of karaages, pork cutlets, or deep-fried prawns, is provided.

### Advantageous Effects of Invention

According to the invention, deep-fried (-like) food products which, when subjected to hot showcase storage, room temperature storage, chilled storage, frozen storage, or microwave cooking, has reduced stringing of the coating, maintains a crisp light mouthfeel, and has suppressed deterioration of the mouthfeel of fillings, can be provided.

### DESCRIPTION OF EMBODIMENTS

In the following description, embodiments of the present invention will be explained by describing specific examples of various components. All of the various components can be used singly or in combination of two or more kinds thereof.

In the present specification, deep-fried food products and deep-fried-like food products will be collectively referred to as “deep-fried (-like) food products”.

(Powdery Breader)

The powdery breader according to the present embodiment is to be used in one or two or more deep-fried (-like) food products selected from the group consisting of food products for hot showcase storage, room temperature storage, chilled storage, frozen storage, and microwave cooking, and the powdery breader includes starch as an essential component.

Specifically, from the viewpoint of suppressing the deterioration of a crispy feeling of the coating after storage or after microwave cooking and obtaining a light mouthfeel, and from the viewpoint of reducing stringing of the coating after storage or after microwave cooking, the powdery breader according to the present embodiment includes a starch at a proportion of 75% by mass or more with respect to the total amount of the powdery breader. Furthermore, from the viewpoints described above, it is preferable that the content of starch in the powdery breader is adjusted to 80% by mass or more, and more preferably 85% by mass or more, with respect to the total amount of the powdery breader.

There are no particular limitations on the upper limit of the content of starch in the powdery breader, and the upper limit is 100% by mass or less with respect to the total amount of the powdery breader. However, the content of starch may be, for example, 99.5% by mass or less, or 99% by mass or less, depending on the type of fillings of the deep-fried (-like) food products, and the like.

The powdery breader according to the present embodiment includes a lowered molecular weight starch as the starch at a particular proportion. This lowered molecular weight starch has an amylose content of 5% by mass or more and a peak molecular weight of 3×10³ or more and 5×10⁴ or less. In the following description, the lowered molecular weight starch will be more specifically explained.

The amylose content in the lowered molecular weight starch is 5% by mass or more, preferably 12% by mass or more, more preferably 22% by mass or more, and even more preferably 50% by mass or more. The upper limit of the amylose content of the lowered molecular weight starch is not limited and is 100% by mass or less.

The lower limit of the peak molecular weight of the lowered molecular weight starch is 3×10³ or more, and preferably 8×10³ or more, from the viewpoint of suppressing deterioration of the crispy feeling of the coating after storage or after microwave cooking, and obtaining a light mouthfeel. Furthermore, the upper limit of the peak molecular weight of the lowered molecular weight starch is 5×10⁴ or less, preferably 3×10⁴ or less, and more preferably 1.5×10⁴ or less, from the viewpoint of reducing stringing of the coating in the deep-fried (-like) food products after storage or after microwave cooking, and from the viewpoint of suppressing greasiness of the coating. Meanwhile, a method for measuring the peak molecular weight of starch after decomposition will be described below in the Examples.

The lower limit of the content of the lowered molecular weight starch in the powdery breader is 3% by mass or more, preferably 8% by mass or more, and even more preferably 13% by mass or more, with respect to the total amount of the powdery breader, from the viewpoint of suppressing deterioration of a crispy feeling of the coating after storage or after microwave cooking and obtaining a light mouthfeel, and from the viewpoint of reducing stringing of the coating after storage or microwave cooking and maintaining a crisp light mouthfeel.

Meanwhile, the upper limit of the content of the lowered molecular weight starch in the powdery breader is 45% by mass or less, preferably 40% by mass or less, and more preferably 35% by mass or less, with respect to the total amount of the powdery breader, from the viewpoint of enhancing the moist feeling of the fillings in the deep-fried (-like) food products after storage or after microwave cooking.

The lowered molecular weight starch is produced from a starch having an amylose content of 5% by mass or more as a raw material.

That is, the amylose content in the raw material starch for the lowered molecular weight starch is 5% by mass or more, preferably 12% by mass or more, more preferably 22% by mass or more, and even more preferably 50% by mass or more. The upper limit of the amylose content in the raw material starch for the lowered molecular weight starch is not limited and is 100% by mass or less.

Regarding a starch having an amylose content of 5% by mass or more, which is a raw material for the lowered molecular weight starch, one kind or two or more kinds selected from the group consisting of high-amylose cornstarch, cornstarch, tapioca starch, sweet potato starch, potato starch, wheat starch, high-amylose wheat starch, rice starch, and modified starches obtained by chemically, physically, or enzymatically processing these raw materials, can be used. From the viewpoint of reducing stringing of the coating and maintaining a crisp light mouthfeel, it is preferable to use one kind or two or more kinds selected from the group consisting of high-amylose cornstarch, cornstarch, and tapioca starch, and it is more preferable to use high-amylose cornstarch. Regarding the amylose content of the high-amylose cornstarch, products having an amylose content of 40% by mass or more are available.

The lowered molecular weight starch is preferably one kind or two or more kinds selected from the group consisting of lowered molecular weight high-amylose cornstarch, lowered molecular weight cornstarch, and lowered molecular weight tapioca starch, and the lowered molecular weight starch is more preferably lowered molecular weight high-amylose cornstarch.

The powdery breader according to the present embodiment is configured such that the particle size satisfies a particular condition.

In regard to the particle size of the powdery breader according to the present embodiment, from the viewpoint of suppressing deterioration of the crispy feeling of the coating after storage or after microwave cooking and enhancing the lightness of the mouthfeel of the coating, the content of oversized particles retained on a sieve with openings of 0.1 mm according to the JIS Z8801-1 standard sieves is 20% by mass or more, preferably 40% by mass or more, more preferably 60% by mass or more, even more preferably 80% by mass or more, and still more preferably 90% by mass or more, with respect to the total amount of the powdery breader. The upper limit of the content of oversized particles retained on a sieve with openings of 0.1 mm in the powdery breader is not limited and is 100% by mass or less.

Furthermore, the content of oversized particles in the powdery breader retained on a sieve with openings of 0.5 mm according to the JIS Z8801-1 standard sieves is preferably 10% by mass or more, and more preferably 20% by mass or more, with respect to the total amount of the powdery breader, from the viewpoint of suppressing deterioration of the crispy feeling of the coating after storage or after microwave cooking, and from the viewpoint of enhancing the lightness of the mouthfeel of the coating. The upper limit is not limited and is 100% by mass or less.

The upper limit of the particle size of the powdery breader is not particularly limited; however, from the viewpoint of increasing the attachability between the coating and the fillings and suppressing falloff of the coating during heating and cooking such as deep-frying in oil, and from the viewpoint of enhancing the moist feeling of the fillings in the deep-fried (-like) food products after storage or after microwave cooking, the content of undersized particles that have passed through a sieve with openings of 3.35 mm according to the JIS Z8801-1 standard sieves is preferably 30% by mass or more, more preferably 40% by mass or more, even more preferably 50% by mass or more, and still more preferably 80% by mass or more, with respect to the total amount of the powdery breader. The upper limit is not limited and is 100% by mass or less.

According to the present embodiment, from the viewpoint of obtaining an appropriately light mouthfeel of the coating material, the degree of swelling in cold water at 25° C. of the powdery breader is preferably 7 or higher, more preferably 7.5 or higher, and even more preferably 9 or higher.

Meanwhile, from the viewpoint of increasing the effect of maintaining a crisp mouthfeel without stringing, the degree of swelling in cold water at 25° C. of the powdery breader is preferably 20 or lower, and more preferably 17 or lower.

Here, the method for measuring the degree of swelling in cold water of the powdery breader will be described in the Examples.

According to the present embodiment, various starches can be used for the powdery breader, in addition to the lowered molecular weight starch described above. Specifically, the type does not matter as long as the starch is a starch that is generally commercially available according to the usage application, for example, a starch for food products or animal feeds. However, one or more can be appropriately selected from starches such as cornstarch, potato starch, tapioca starch, and wheat starch; and modified starches obtained by chemically, physically, or enzymatically processing these starches. The starch other than the lowered molecular weight starch in the powdery breader is preferably one kind or two or more kinds of starches selected from the group consisting of cornstarch, wheat starch, potato starch, tapioca starch, and crosslinked starches thereof, and the starch is more preferably cornstarch.

In the powdery breader according to the present embodiment, a component other than starch may be incorporated.

Specific examples of the component other than starch include saccharides (excluding polysaccharides) such as sugar; proteins such as gluten; grain flours such as soy flour (for example, defatted soy flour); polysaccharides such as pectin, and other gums; oils and fats; dyes; emulsifying agents; and insoluble salts such as calcium carbonate and calcium sulfate.

Since the lightness of the mouthfeel of the coating can be regulated by incorporating an emulsifier, the mouthfeel of the coating can be varied according to the type of the deep-fried (-like) food product, the type of the fillings, and the like.

Furthermore, an air-bubble structure in the coating material can be stabilized by adding an insoluble salt such as calcium carbonate. For example, it is preferable to add the insoluble salt to the powdery breader at a proportion of 0.1% by mass or more and 5% by mass or less.

The lightness of the mouthfeel of the coating may also be regulated by incorporating grain flour such as defatted soy flour.

Next, a method for producing a powdery breader according to the present embodiment will be explained. The method for producing a powdery breader according to the present embodiment includes:

subjecting a starch having an amylose content of 5% by mass or more to a molecular weight reduction treatment and obtaining a lowered molecular weight starch having a peak molecular weight of 3×10³ or more and 5×10⁴ or less;

incorporating the lowered molecular weight starch into a raw material at a proportion of 3% by mass or more and 45% by mass or less, and subjecting the raw material in which the sum of the content of the lowered molecular weight starch and the content of a starch other than the lowered molecular weight starch is 75% by mass or more, to a gelatinization treatment; and

screening a partially or fully gelatinized product obtained by the gelatinization treatment so that the content of oversized particles retained on a sieve with openings of 0.1 mm is adjusted to 20% by mass or more and 100% by mass or less.

In regard to the powdery breader obtained in the production process described above, it is preferable that the degree of swelling in cold water at 25° C. is 7 or higher and 20 or lower. The degree of swelling in cold water of the powdery breader is more preferably 7.5 or higher and 20 or lower, and even more preferably 9 or higher and 17 or lower.

The step of obtaining a lowered molecular weight starch is a step of decomposing a starch having an amylose content of 5% by mass or more and obtaining a lowered molecular weight starch. The term decomposition as used herein means decomposition associated with molecular weight reduction of starch, and representative decomposition methods include decomposition brought by an acid treatment, an oxidation treatment, or an enzymatic treatment. Among these, from the viewpoints of a decomposition rate, cost, and reproducibility of the decomposition reaction, an acid treatment is more preferred.

For the step of gelatinizing a raw material, a general method that is used for heat gelatinization of starch can be used. Specifically, heat gelatinization methods of using machines such as a drum dryer, a jet cooker, an extruder, and a spray dryer are known. However, in the present embodiment, heat gelatinization by an extruder or a drum dryer is suitable from the viewpoint of more securely obtaining a powdery breader having a degree of swelling in cold water that satisfies the above-mentioned particular conditions, and an extruder is more suitable.

When a method of using an extrusion granulator based on an extruder or the like is used, since at least the vicinity of the surface of a powdery breader is gelatinized, and a powdery breader having an adequately low density is obtainable, a powdery breader having enhanced lightness of the mouthfeel of the coating by suppressing deterioration of a crispy feeling of the coating after storage or after microwave cooking, and having an enhanced moist feeling of the fillings in the deep-fried (-like) food product, can be obtained more stable. In the case of performing an extruder treatment, usually, water is added to a raw material including starch, and thereby the moisture content is adjusted to about 10% to 60% by mass. Subsequently, the raw material is heated and swelled under the conditions of, for example, a barrel temperature of 30° C. to 200° C., an exit temperature of 80° C. to 180° C., a speed of screw rotation of 100 to 1,000 rpm, and a heat treatment time of 5 to 60 seconds. The degree of gelatinization when using an extruder is adjusted to, for example, 20% or higher, and preferably 30% or higher, from the viewpoint of enhancing the attachability between the coating material and the fillings. Meanwhile, from the viewpoint of suppressing deterioration of a crispy feeling of the coating, the degree of gelatinization when using an extruder is, for example, 100% or lower, preferably 80% or lower, and more preferably 70% or lower.

When a gelatinization treatment using a drum dryer is employed, since the degree of gelatinization can be increased more sufficiently, a powdery breader having enhanced lightness of the mouthfeel of the coating by suppressing deterioration of a crispy feeling of the coating after storage or after microwave cooking, and having an enhanced moist feeling of the fillings in the deep-fried (-like) food product, can be stably obtained. In the case of performing a drum dryer treatment, usually, a slurry having a heavy Baume degree of about 10 to 22 of a raw material including starch is passed through an ONLATOR and thereby heated to an exit temperature of about 90° C. to 140° C. to obtain a gelatinized liquid. This gelatinized liquid is immediately spread thinly over a drum dryer that has been heated to about 100° C. to 200° C. and is heated and dried, and the resultant is scraped off from the drum dryer. The degree of gelatinization when using a drum dryer is adjusted to, for example, 20% or higher, and preferably 30% or higher, from the viewpoint of enhancing the attachability between the coating material and the fillings. Meanwhile, from the viewpoint of suppressing deterioration of a crispy feeling of the coating, the degree of gelatinization when using a drum dryer is adjusted to, for example, 100% or lower, and preferably 98% or lower.

Even if the partially or fully gelatinized product obtained in the above-described step is subjected to particle size adjustment by means of pulverization or the like, the degree of gelatinization substantially does not change.

In regard to the method of the present embodiment, a powdery breader having a degree of swelling in cold water that satisfies particular conditions can be obtained by, for example, a step of subjecting the particular raw material to a gelatinization treatment.

Then, the partially or fully gelatinized product is screened so that the content of oversized particles retained on a sieve with openings of 0.1 mm is adjusted to 20% by mass or more and 100% by mass or less. At this time, when the size of the partially or fully gelatinized product is in the particular range described above, the partially or fully gelatinized product thus obtained may be directly used as the powdery breader. Alternatively, a powdery breader having the particle size in the particular range described above may also be obtained by pulverizing the partially or fully gelatinized product, sieving the resultant, and thereby appropriately adjusting the particle size, as necessary. In this way, the mouthfeel of the coating material becomes adequately light, and an effect of maintaining a crisp mouthfeel without stringing can be obtained more stable.

Since the powdery breader obtainable in the present embodiment includes the above-described lowered molecular weight starch and is configured such that the starch content, the content of the lowered molecular weight starch, and the particle size all satisfy particular conditions, the mouthfeel of one or two or more deep-fried (-like) food products selected from the group consisting of food products for hot showcase storage, room temperature storage, chilled storage, frozen storage, and microwave cooking can be enhanced.

Specifically, by using the powdery bread according to the present embodiment, when deep-fried (-like) food products are subjected to hot showcase storage, room temperature storage, chilled storage, frozen storage, or microwave cooking, stringing of the coating can be reduced, a crisp light mouthfeel can be maintained, and deterioration of the mouthfeel of fillings can be suppressed.

According to the present embodiment, deep-fried (-like) food products that show suppressed deterioration of a crispy feeling of the coating, suppressed deterioration of the mouthfeel of the fillings, and excellent lightness of the mouthfeel of the coating when subjected to, for example, hot showcase storage, room temperature storage, chilled storage, frozen storage, or microwave cooking, can be obtained. For example, according to the present embodiment, it is also possible to enhance a moist feeling of fillings obtainable when the deep-fried (-like) food products are subjected hot showcase storage, room temperature storage, chilled storage, frozen storage, or microwave cooking.

According to the present embodiment, it is also possible to suppress, for example, greasiness of the coating of deep-fried (-like) food products after hot showcase storage, after room temperature storage, after chilled storage, after frozen storage, or after microwave cooking.

(Breader Mix)

According to the present embodiment, the breader mix includes the powdery breader according to the present embodiment as described above.

The content of the powdery breader in the breader mix is preferably 20% by mass or more, more preferably 30% by mass or more, even more preferably 45% by mass or more, still more preferably 55 by mass or more, and even more preferably 75% by mass or more, with respect to the total amount of the breader mix, from the viewpoint of suppressing stringing of the coating after storage or after microwave cooking, maintaining a crisp light mouthfeel, and suppressing deterioration of the mouthfeel of fillings. Furthermore, the content is 100% by mass or less, and preferably 90% by mass or less.

The breader mix may include a component other than the powdery breader. The component other than the powdery breader may be one kind or two or more kinds selected from the group consisting of wheat flour, breadcrumbs, and starch. When these components are incorporated, the attachability of the breader mix to fillings is improved, and separation between the coating and the fillings during deep-frying can be suppressed.

Examples of the starch to be mixed in as a component other than the powdery breader include unmodified starch such as tapioca starch, cornstarch, rice starch, potato starch, wheat starch, waxy cornstarch, or sago starch;

crosslinked starch such as crosslinked tapioca starch; acid-treated starch such as acid-treated tapioca starch; and other modified starch. Preferably, one kind or two or more kinds selected from the group consisting of cornstarch, rice starch, wheat starch, and crosslinked starch may be mentioned.

The type of the starch to be mixed in as a component other than the powdery breader may be identical with or different from the type of the starch included in the powdery breader.

(Coating Material)

The coating material according to the present embodiment includes the breader mix according to the present embodiment described above.

Regarding the coating material, a batter that coats the outer side of fillings and is provided on the inner side of the breader mix, may be further included. At this time, the batter may also include the powdery breader according to the present embodiment described above.

(Deep-Fried (-Like) Food Product)

The deep-fried (-like) food product according to the present embodiment is for hot showcase storage, room temperature storage, chilled storage, frozen storage, or microwave cooking and includes the coating material according to the present embodiment described above. The usage application of the deep-fried (-like) food product includes one or two or more selected from the group consisting of hot showcase storage, room temperature storage, chilled storage, frozen storage, and microwave cooking.

In regard to the deep-fried (-like) food product, the coating material may coat a portion of fillings, or may coat the entirety of fillings. Furthermore, the coating material may attach to a portion of fillings, or may attach to the entirety of fillings.

Specific examples of the fillings include:

meats such as chicken meat, pork, and beef, and processed products thereof;

seafoods such as prawn, squid, scallop adductor, and fish, and processed products thereof;

vegetables such as potato, onion, pumpkin, pimento, and shiitake mushroom, and processed products thereof;

eggs such as chicken egg and quail egg, and processed products thereof;

cereals such as rice and corn, and processed products thereof;

beans such as soybean, and processed products thereof;

dairy products such as cheese; and

bread dough, and doughnut dough.

Furthermore, specific examples of the deep-fried (-like) food product include karaage; tatsutaage; deep-fried chicken; chicken nuggets; cutlets such as pork cutlet and minced meat cutlet; crockets; deep-fries such as deep-fried prawn; and deep-fried buns such as curry bun and doughnut.

The method for producing a deep-fried (-like) food product is not limited; however, for example, the method for producing a deep-fried (-like) food product may include:

obtaining the powdery breader according to the present embodiment described above;

preparing a breader mix including the powdery breader;

attaching the breader mix to the outer side of fillings; and

obtaining a deep-fried (-like) food product by heating and cooking the fillings attached with the breader mix.

Specific examples of heating and cooking include deep-frying in an edible oil at about 140° C. to 220° C., and heating on an oiled frying pan or hot plate. It is also acceptable to perform heating and cooking by means of dry-heat cooking in an oven or the like, microwave heating and cooking (microwave cooking), superheated steam cooking, or the like. For example, the deep-frying temperature in the case of deep-frying in an edible oil is preferably 185° C. to 200° C. from the viewpoint of enhancing a crispy feeling, and the temperature is preferably 160° C. to 190° C. from the viewpoint of enhancing a moist feeling.

The deep-fried (-like) food product may also be a food product obtainable by coating a filling with a coating material and then subjecting the coated filling to a heating treatment process such as preliminary deep-frying, a storage process such as frozen storage, and a reheating process such as deep-frying in oil again.

According to the present embodiment, the deep-fried (-like) food product may also be a deep-fried-like food product (non-fried food product) having a taste and a mouthfeel similar to those of a deep-fried food product, which is not subjected to a process of frying (deep-frying) in oil but is produced by firing cooking or steam cooking carried out using a small amount of oil.

For a deep-fried-liked food product obtainable by these methods, it is more preferable that the fillings are coated with a coating material including an oil or fat, or the coating material is sweated in an oil or fat.

The deep-fried (-like) food product thus obtained is subjected to hot showcase storage, room temperature storage, chilled storage, or frozen storage, or is subjected to re-cooking by means of microwave cooking.

The storage temperature in a hot showcase is a temperature higher than room temperature, and for example, the temperature can be set to 50° C. or higher and 80° C. or lower.

The storage temperature at room temperature may be set to, for example, 10° C. or higher and lower than 50° C.

The storage temperature for chilling may be set to, for example, 0° C. or higher and lower than 10° C.

The storage temperature for freezing may be set to, for example, −100° C. or higher and lower than 0° C.

### EXAMPLES

Examples of the present invention will be described below; however, the purport of the invention is not to be limited to these.

In the following Examples, unless particularly stated otherwise, the unit “percent (%)” is “percent by mass (mass %)”. Furthermore, unless particularly stated otherwise, the unit “parts” is “parts by mass”.

(Raw Materials)

As raw materials, the following materials were mainly used.

Wheat flour (manufactured by Nisshin Flour Milling, Inc., NISSHIN FLOUR)

Potato starch (manufactured by J-Oil Mills, Inc., JELCALL BP-200)

Crosslinked tapioca starch (manufactured by J-Oil Mills, Inc., JELCALL TP-4)

Acid-treated tapioca starch (manufactured by J-Oil Mills, Inc., JELCALL SP-2)

Tapioca starch (manufactured by J-Oil Mills, Inc.)

Cornstarch (manufactured by J-Oil Mills, Inc., CORN STARCH Y)

High-amylose cornstarch (manufactured by J-Oil Mills, Inc., HS-7, amylose content 70% by mass)

Rice starch (manufactured by Joetsu Starch Co., Ltd., FINE SNOW)

Wheat starch (manufactured by Chiba Flour Milling Co., Ltd., WS-525)

Waxy cornstarch (manufactured by J-Oil Mills, Inc., WAXY CORN STARCH Y)

Soy sauce (manufactured by Kikkoman Corporation, dark soy sauce)

Cooking sake (manufactured by Mizkan Holdings Co., Ltd., pure rice sake for cooking)

Mirin (manufactured by Kikkoman Corporation, HON MIRIN)

Polysaccharide thickener (manufactured by DSP Kogyo Food & Chemical Co., Ltd., ECO-GUM F)

Paprika powder (manufactured by S&B Foods, Inc., paprika)

Breadcrumbs (manufactured by Kyoei Foods Co., Ltd., raw breadcrumbs)

Canola oil (manufactured by J-Oil Mills, Inc., SARASARA Canola Oil)

Gelatinized cornstarch (manufactured by J-Oil Mills, Inc., product obtained by gelatinization processing CORN STARCH Y with a drum dryer)

White sesame (manufactured by Mitake Food Industry Co., Ltd., Irigoma-Shiro)

Table salt (manufactured by Salt Industry Center of Japan, table salt)

Amino acid seasoning (manufactured by Ajinomoto Co., Inc., AJINOMOTO)

White pepper (manufactured by Gaban Co., Ltd., white pepper)

Garlic powder (manufactured by Gaban Co., Ltd., garlic powder)

Corn flour (manufactured by Gaban Co., Ltd., corn flour)

Oil or fat-processed tapioca starch (manufactured by J-Oil Mills, Inc., HB-150)

(Production of Powder Breader)

In the present Example, a powder breader was produced using a lowered molecular weight starch obtained by an acid treatment. The production method is described below.

(Process for Preparing Acid-Treated High Amylose Cornstarch)

High-amylose cornstarch was suspended in water to produce a 35.6% (w/w) slurry, and the slurry was heated to 50° C. To this, an aqueous solution of hydrochloric acid prepared at 4.25 N was added, with stirring, in a 1/9-fold amount at a slurry weight ratio, and a reaction was initiated. After the reaction was performed for 16 hours, the system was neutralized with 3% NaOH, and the resultant was washed with water, dehydrated, and dried. Thus, an acid-treated high-amylose cornstarch was obtained.

The peak molecular weight of the acid-treated high-amylose cornstarch thus obtained was measured by the following method, and the peak molecular weight was 1.2×10⁴.

(Method for Measuring Peak Molecular Weight)

The measurement of the peak molecular weight was carried out by the following procedure using an HPLC unit manufactured by Tosoh Corporation (pump DP-8020, RI detector RS-8021, degassing apparatus SD-8022).

(1) A sample was pulverized, and the particle size of the pulverized product was adjusted to a particle size that passes through a sieve with openings of 0.15 mm according to the JIS Z8801-1 standard sieves. This sample was suspended in a mobile phase to a concentration of 1 mg/mL, and the suspension liquid was heated for 3 minutes at 100° C. Thus, the sample was completely dissolved. Filtration was performed using a 0.45-μm filtration filter (manufactured by Advantec MFS, Inc., DISMIC-25HP PTFE 0.45 μm), and the filtrate was used as an analysis sample.

(2) The molecular weight was measured under the following analysis conditions. Column: two units of TSKgel α-M (7.8 mmϕ, 30 cm) (manufactured by Tosoh Corporation)

Flow rate: 0.5 mL/min, mobile phase: 5 mM NaNO₃-containing 90% (v/v) dimethyl sulfoxide solution, column temperature: 40° C., analysis amount: 0.2 mL

(3) The detector data were collected using a software program (Multistation GPC-8020 model II data collection ver 5.70, manufactured by Tosoh Corporation), and the molecular weight peaks were calculated. For the calibration curve, Pullulans with known molecular weights (manufactured by Showa Denko K. K., SHODEX Standard P-82) were used.

(Method for Producing Powdery Breader)

79% by mass of cornstarch, 20% by mass of an acid-treated high-amylose cornstarch (peak molecular weight 1.2×10⁴), and 1% by mass of calcium carbonate were mixed in a bag until the mixture became sufficiently uniform. The mixture was subjected to pressurized heating treatment using a twin-screw extruder (KEI-45 manufactured by Kohwa Kogyo, Inc.). The treatment conditions were as follows: raw material supply: 450 g/min, water addition: 17% by mass, barrel temperature: 50° C., 70° C., and 100° C. from the raw material inlet toward the exit, exit temperature: 100° C. to 110° C., and speed of screw rotation: 250 rpm. A gelatinized product obtained by an extruder treatment in this manner was dried at 110° C., and the moisture content was adjusted to about 10% by mass. The degree of gelatinization of the gelatinized product thus obtained was measured by the method described below, and the degree of gelatinization was 51%.

Next, the dried gelatinized product was pulverized with a tabletop cutter pulverizer, and then the pulverized product was screened with JIS-Z8801-1 standard sieves. The gelatinized product thus screened was mixed at the mixing ratio shown in Table 1, and compositions 1 to 8 of powdery breader were produced. The degrees of swelling in cold water of the compositions thus obtained were measured by the method described below, and the degrees of swelling in cold water were 10.0.

TABLE 1

| | Composition | Com- | Com- | | | | | |
|---|---|---|---|---|---|---|---|---|
| Particle size | 1 | position 2 | position 3 | Composition 4 | Composition 5 | Composition 6 | Composition 7 | Composition 8 |
| Passed through mesh with | | | | | | | | 50% |
| openings of 7.26 mm | | | | | | | | |
| Retained on mesh with | | | | | | | | |
| openings of 3.35 mm | | | | | | | | |
| Passed through mesh with | | 100% | 50% | | | | | 35% |
| openings of 3.35 mm | | | | | | | | |
| Retained on mesh with | | | | | | | | |
| openings of 1.4 mm | | | | | | | | |
| Passed through mesh with | 20% | | 50% | 100% | 50% | | | 10% |
| openings of 1.4 mm | | | | | | | | |
| Retained on mesh with | | | | | | | | |
| openings of 0.5 mm | | | | | | | | |
| Passed through mesh with | 75% | | | | 50% | 50% | | 5% |
| openings of 0.5 mm | | | | | | | | |
| Retained on mesh with | | | | | | | | |
| openings of 0.1 mm | | | | | | | | |
| Passed through mesh with | 5% | | | | | 50% | 100% | |
| openings of 0.1 mm | | | | | | | | |

(Method for Measuring Degree of Gelatinization)

The measurement of the degree of gelatinization of starch in a gelatinized product was carried out by the β-amylase-pullulanase (BAP) method.

(1) The gelatinized product was pulverized in advance, and the particle size was adjusted to a particle size that could pass through a sieve with openings of 0.15 mm according to the JIS Z8801-1 standard sieves. The resultant was used as a measurement sample.

(2) The degree of gelatinization (%) of starch in the gelatinized product was measured according to the method described in “New method for measuring degree of gelatinization and degree of aging of starch using β-amylase-pullulanase (BAP) system”, Denpun Kagaku (Starch Science), Vol. 28, No. 4, pp. 235-240 (1981).

(Method for measuring degree of swelling in cold water)

(1) A sample was heated and dried at 130° C., and moisture was measured using a moisture meter (Kensei Co., Ltd., electromagnetic moisture meter: Product No. MX50). The weight of the dried material was calculated from the moisture value thus obtained.

(2) 1 g of the sample as calculated relative to this weight of the dried material was dispersed in 50 mL of water at 25° C., and the dispersion liquid was mildly stirred in a constant temperature tank at 25° C. for 30 minutes. Subsequently, the dispersion liquid was centrifuged for 10 minutes at 3,000 rpm (centrifuge: manufactured by Hitachi Koki Co., Ltd., Hitachi tabletop centrifuge CT6E type; rotor: T4SS type swing rotor; adaptor: 50TC×2S adaptor), and the dispersion liquid was divided into a precipitation layer and a supernatant layer.

(3) The supernatant layer was removed, the weight of the precipitation layer was measured, and this was denoted as B (g).

(4) The precipitation layer was dried to solid (105° C., constant weight), and the weight of the dried product was denoted as C (g).

(5) The ratio B/C was designated as the degree of swelling in cold water.

### Examples 1 to 23 and Comparative Examples 1 and 2

Karaages were produced by the following method, and the mouthfeel before and after storage in a hot showcase was evaluated.

(Method for Producing Karaage)

Peeled chicken legs were cut into pieces each weighing 20 g. 4 parts by weight of soy sauce, 4 parts by weight of cooking sake, and 2 parts by weight of mirin were rubbed well onto 100 parts by weight of this chicken leg meat, and then the meat was soaked therein for 30 minutes at 4° C. in a refrigerator. Thus, the chicken leg meat was preliminarily seasoned.

Next, 11.4 parts by weight of wheat flour, 0.09 parts by weight of a polysaccharide thickener, 0.06 parts by weight of a paprika powder, and 18.45 parts by weight of water were mixed, and the mixture was carefully mixed until no lumps were left. Thus, a batter liquid was produced. This batter liquid was added to the preliminarily seasoned meat, and the meat was marinated well. Thus, battered meat was obtained. At this time, the amount of the batter liquid attached to the meat was about 5 to 6 g per piece of cut meat.

Next, the breader sample of each Example was thinly dispersed in a container of an appropriate size, and the battered meat was rolled over the breader sample. Thus, the breader sample was uniformly attached to the meat, and breaded meat was obtained. At this time, in Examples 1 to 5 and Comparative Example 1, the amount of the breader sample attached to the meat was calculated from the amount of leftover breader sample. The breaded meat was deep-fried in canola oil at about 170° C. for 5 minutes, and then oil was drained off well. The deep-fried meat was transferred into a metal bat and was left to cool at room temperature for about 15 minutes.

(Evaluation of Mouthfeel)

The karaage that had been deep-fried and left to cool was first evaluated for the mouthfeel, and then the deep-fried food was stored in a hot showcase (NH-202 manufactured by Annaka Co., Ltd., memory setting: weak) for 6 hours. At this time, the ambient temperature in the showcase during the storage in the hot showcase was about 70° C. on the average. After 6 hours of storage in the hot showcase had passed, the deep-fried food was left to cool for about 15 minutes at room temperature, and then the mouthfeel was evaluated again.

The evaluation of the mouthfeel was carried out by four panelists for the following items (1) to (5) according to the following criteria, respectively. Then, the average value of the scores given by the four panelists was calculated for each of the items.

(1) Crispy Feeling of Coating

5: Very crisp mouthfeel

4: Crisp mouthfeel

3: Slightly crisp mouthfeel

2: Not very crisp

1: Not crisp at all

(2) Lightness of Mouthfeel of Coating

5: Very light mouthfeel

4: Light mouthfeel

3: Slightly light mouthfeel

2: Choky and heavy mouthfeel

1: Very choky and heavy mouthfeel

(3) Stringing of Coating

5: The coating does not feel stringing at all and has very good chewiness

4: The coating does not feel stringing and has good chewiness

3: The coating does not much feel stringing and has slightly good chewiness

2: The coating is slightly stringing and has poor chewiness

1: The coating is strongly stringing and has very poor chewiness

(4) Greasiness of Coating

5: Greasiness is not felt at all

4: Greasiness is not felt

3: Greasiness is not much felt

2: Greasiness is slightly felt

1: Greasiness is felt strongly

(5) Moist Feeling of Fillings (Meat)

5: Feels very moist

4: Feels moist

3: Feels slightly moist

2: Feels dry

1: Feels very dry

(Evaluation of Workability)

Workability at the time of producing the karaage was evaluated by one trial cook for the following items (6) and (7) according to the following criteria, respectively.

(6) Attachability of Coating to Meat

5: Attachability of the breader sample is very satisfactory

4: Attachability of the breader sample is satisfactory

3: Attachability of the breader sample is slightly satisfactory

2: Attachability of the breader sample is slightly poor

1: Attachability of the breader sample is very poor

(7) Separation of Coating During Deep-Frying

5: Separation occurs very rarely

4: Separation occurs rarely

3: Separation occurs neither rarely nor frequently

2: Separation occurs frequently

1: Separation occurs very frequently

### Examples 1 to 5 and Comparative Example 1

Breader mixes of the compositions shown in Table 2A and Table 2B were produced using the powdery breader of composition 1 or wheat flour. The breader mixes were used as breader samples.

The evaluation results obtained before storage and after storage in a hot showcase for karaages thus obtained are presented in Table 2A and Table 2B, respectively.

### Table 2

TABLE 2A
Before storage in hot showcase

| | Example 1 | Example 2 | Example 3 | Example 4 | Example 5 | Comparative |
|---|---|---|---|---|---|---|
| | Composition 1 | Composition 1 80% | Composition 1 60% | Composition 1 50% | Composition 1 40% | Example 1 |
| Breader mix | 100% | Wheat flour 20% | Wheat flour 40% | Wheat flour 50% | Wheat flour 60% | Wheat flour 100% |
| (1) Crispy feeling | 4.5 | 4.8 | 4.8 | 4.5 | 4.0 | 3.5 |
| of coating | | | | | | |
| (2) Lightness of | 4.8 | 4.8 | 4.3 | 4.0 | 4.3 | 3.5 |
| mouthfeel of coating | | | | | | |
| (3) Stringing of coating | 4.8 | 4.8 | 4.3 | 4.3 | 4.3 | 4.0 |
| (4) Greasiness of coating | 4.3 | 4.3 | 4.0 | 3.8 | 3.3 | 3.5 |
| (5) Moist feeling of | 3.5 | 4.0 | 4.3 | 4.3 | 3.8 | 3.3 |
| fillings (meat) | | | | | | |
| (6) Attachability of | 3 | 4 | 5 | 5 | 5 | 4 |
| coating to meat | | | | | | |
| (7) Separation of coating | 3 | 4 | 5 | 5 | 5 | 4 |
| during deep-frying | | | | | | |
| Amount of breader | 1.4 g/piece | 1.8 g/piece | 1.9 g/piece | 1.8 g/piece | 1.8 g/piece | 1.6 g/piece |
| sample attached (average | | | | | | |
| per 10 pieces) | | | | | | |

TABLE 2B
After storage in hot showcase

| | Example 1 | Example 2 | Example 3 | Example 4 | Example 5 | Comparative |
|---|---|---|---|---|---|---|
| | Composition 1 | Composition 1 80% | Composition 1 60% | Composition 1 50% | Composition 1 40% | Example 1 |
| Breader mix | 100% | Wheat flour 20% | Wheat flour 40% | Wheat flour 50% | Wheat flour 60% | Wheat flour 100% |
| (1) Crispy feeling | 4.3 | 4.5 | 4.0 | 3.3 | 3.0 | 2.3 |
| of coating | | | | | | |
| (2) Lightness of | 4.8 | 4.3 | 3.8 | 3.3 | 3.0 | 2.5 |
| mouthfeel of coating | | | | | | |
| (3) Stringing of coating | 3.8 | 4.0 | 4.0 | 3.5 | 3.3 | 1.8 |
| (4) Greasiness of coating | 4.3 | 4.3 | 4.0 | 3.8 | 3.3 | 2.8 |
| (5) Moist feeling of | 3.0 | 4.0 | 4.0 | 3.3 | 3.0 | 2.3 |
| fillings (meat) | | | | | | |

From Table 2A and Table 2B, in Examples 1 to 5 in which composition 1 was used as the breader sample, the crispy feeling of the coating, lightness of the mouthfeel of the coating, and the moist feeling of the fillings (meat) after storage in hot showcase could be enhanced, also, stringing and greasiness of the coating could be suppressed, compared to Comparative Example 1 in which only wheat flour was used.

### Examples 6 and 7

Breader mixes of the compositions shown in Table 3A and Table 3B were produced using the powdery breader of composition 1 and breadcrumbs, and these were used as breader samples.

The breadcrumbs used in the present Examples were obtained by pulverizing with a tabletop pulverizer and then adjusting the particle size using the JIS Z8801-1 standard sieves. Specifically, breadcrumbs having the particle size adjusted to include 20% by mass of a fraction that passed through a mesh with openings of 1.4 mm and was retained on a mesh with openings of 0.5 mm; 75% by mass of a fraction that passed through a mesh with openings of 0.5 mm and was retained on a mesh with openings of 0.1 mm; and 5% by mass of a fraction that passed through a mesh with openings of 0.1 mm, were used.

The evaluation results obtained before storage and after storage in a hot showcase for karaages thus obtained are presented in Table 3A and Table 3B, respectively.

### Table 3

TABLE 3A
Before storage in hot showcase

| | Example 2 | Example 4 | Example 6 | Example 7 |
|---|---|---|---|---|
| Breader mix | Composition 1 80% | Composition 1 50% | Composition 1 80% | Composition 1 50% |
| | Wheat flour 20% | Wheat flour 50% | Breadcrumbs 20% | Breadcrumbs 50% |
| (1) Crispy feeling of coating | 4.8 | 4.5 | 4.8 | 4.5 |
| (2) Lightness of mouthfeel of | 4.8 | 4.0 | 4.8 | 4.3 |
| coating | | | | |
| (3) Stringing of coating | 4.8 | 4.3 | 4.5 | 4.3 |
| (4) Greasiness of coating | 4.3 | 3.8 | 4.3 | 4.0 |
| (5) Moist feeling of fillings | 4.0 | 4.3 | 4.3 | 4.0 |
| (meat) | | | | |
| (6) Attachability of coating to | 4 | 5 | 4 | 4 |
| meat | | | | |
| (7) Separation of coating during | 4 | 5 | 4 | 4 |
| deep-frying | | | | |

TABLE 3B
After storage in hot showcase

| | Example 2 | Example 4 | Example 6 | Example 7 |
|---|---|---|---|---|
| Breader mix | Composition 1 80% | Composition 1 50% | Composition 1 80% | Composition 1 50% |
| | Wheat flour 20% | Wheat flour 50% | Breadcrumbs 20% | Breadcrumbs 50% |
| (1) Crispy feeling of coating | 4.5 | 3.3 | 4.5 | 4.0 |
| (2) Lightness of mouthfeel of | 4.3 | 3.3 | 4.3 | 4.0 |
| coating | | | | |
| (3) Stringing of coating | 4.0 | 3.5 | 4.0 | 4.0 |
| (4) Greasiness of coating | 4.3 | 3.8 | 4.0 | 3.8 |
| (5) Moist feeling of fillings | 4.0 | 3.3 | 4.0 | 3.5 |
| (meat) | | | | |

From Table 3A and Table 3B, even in a case in which composition 1 and breadcrumbs were used in combination, the crispy feeling of the coating, lightness of the mouthfeel of the coating, and the moist feeling of the filings (meat) after storage in hot showcase could be enhanced, also, stringing and greasiness of the coating could be suppressed, compared to Comparative Example 1.

### Examples 8 to 13

Breader mixes of the compositions shown in Table 4A and Table 4B were produced using the powdery breader of composition 1 and unmodified starch, and these were used as breader samples.

The evaluation results obtained before storage and after storage in hot showcase for the karaages thus obtained are presented in Table 4A and Table 4B, respectively.

### Table 4

TABLE 4A
Before storage in hot showcase

| | Example 8 | Example 9 | Example 10 | Example 11 | Example 12 | Example 13 |
|---|---|---|---|---|---|---|
| | Composition 1 80% | Composition 1 80% | Composition 1 80% | Composition 1 80% | Composition 1 80% | Composition 1 80% |
| Breader mix | Tapioca starch 20% | Cornstarch 20% | Rice starch 20% | Potato starch 20% | Wheat starch 20% | Waxy cornstarch 20% |
| (1) Crispy feeling | 4.5 | 4.5 | 4.5 | 4.3 | 4.8 | 4.0 |
| of coating | | | | | | |
| (2) Lightness of | 4.0 | 3.8 | 4.5 | 3.8 | 4.5 | 4.0 |
| mouthfeel of | | | | | | |
| coating | | | | | | |
| (3) Stringing of | 4.0 | 4.5 | 4.0 | 4.5 | 4.5 | 4.0 |
| coating | | | | | | |
| (4) Greasiness | 3.8 | 4.0 | 4.8 | 4.5 | 4.5 | 3.8 |
| of coating | | | | | | |
| (5) Moist feeling | 4.0 | 4.0 | 4.0 | 4.0 | 4.0 | 4.0 |
| of fillings (meat) | | | | | | |
| (6) Attachability | 4 | 4 | 4 | 4 | 4 | 4 |
| of coating to meat | | | | | | |
| (7) Separation of | 4 | 4 | 4 | 4 | 4 | 4 |
| coating during | | | | | | |
| deep-frying | | | | | | |

TABLE 4B
After storage in hot showcase

| | Example 8 | Example 9 | Example 10 | Example 11 | Example 12 | Example 13 |
|---|---|---|---|---|---|---|
| | Composition 1 80% | Composition 1 80% | Composition 1 80% | Composition 1 80% | Composition 1 80% | Composition 1 80% |
| Breader mix | Tapioca starch 20% | Cornstarch 20% | Rice starch 20% | Potato starch 20% | Wheat starch 20% | Waxy cornstarch 20% |
| (1) Crispy feeling | 4.0 | 4.3 | 4.3 | 4.0 | 4.5 | 4.0 |
| of coating | | | | | | |
| (2) Lightness of | 4.0 | 3.5 | 4.0 | 3.5 | 4.0 | 3.0 |
| mouthfeel of | | | | | | |
| coating | | | | | | |
| (3) Stringing of | 3.3 | 3.5 | 4.0 | 3.3 | 4.0 | 3.0 |
| coating | | | | | | |
| (4) Greasiness | 3.0 | 4.0 | 4.0 | 3.5 | 4.3 | 3.3 |
| of coating | | | | | | |
| (5) Moist feeling | 3.8 | 3.5 | 3.5 | 3.5 | 3.5 | 3.5 |
| of fillings (meat) | | | | | | |

From Table 4A and Table 4B, even in a case in which composition land various unmodified starches were used in combination, the crispy feeling of the coating, lightness of the mouthfeel of the coating, and the moist feeling of the fillings (meat) after storage in hot showcase could be enhanced, also, stringing and greasiness of the coating could be suppressed, compared to Comparative Example 1.

### Examples 14 to 18

Breader mixes of the compositions shown in Table 5A and Table 5B were produced using the powdery breader of composition 1 and modified starches, and these were used as breader samples.

The evaluation results obtained before storage and after storage in hot showcase for karaages thus obtained are presented in Table 5A and Table 5B, respectively.

### Table 5

TABLE 5A
Before storage in hot showcase

| | Example 14 | Example 15 | Example 16 | Example 17 | Example 18 |
|---|---|---|---|---|---|
| Breader mix | Composition 1 80% | Composition 1 50% | Composition 1 80% | Composition 1 50% | Composition 1 60% |
| | Crosslinked tapioca | Crosslinked tapioca | Acid-treated tapioca | Acid-treated tapioca | Crosslinked tapioca |
| | starch 20% | starch 50% | starch 20% | starch 50% | starch 20% |
| | | | | | Wheat flour 20% |
| (1) Crispy feeling of coating | 5.0 | 5.0 | 4.8 | 4.8 | 4.8 |
| (2) Lightness of mouthfeel of | 4.8 | 4.5 | 4.8 | 4.5 | 4.3 |
| coating | | | | | |
| (3) Stringing of coating | 4.8 | 4.8 | 4.5 | 4.3 | 4.8 |
| (4) Greasiness of coating | 4.3 | 4.0 | 4.0 | 3.0 | 4.3 |
| (5) Moist feeling of fillings | 4.5 | 4.3 | 4.5 | 4.3 | 4.0 |
| (meat) | | | | | |
| (6) Attachability of coating to | 4 | 4 | 4 | 4 | 5 |
| meat | | | | | |
| (7) Separation of coating during | 4 | 4 | 4 | 4 | 5 |
| deep-frying | | | | | |

TABLE 5B
After storage in hot showcase

| | Example 14 | Example 15 | Example 16 | Example 17 | Example 18 |
|---|---|---|---|---|---|
| Breader mix | Composition 1 80% | Composition 1 50% | Composition 1 80% | Composition 1 50% | Composition 1 60% |
| | Crosslinked tapioca | Crosslinked tapioca | Acid-treated tapioca | Acid-treated tapioca | Crosslinked tapioca |
| | starch 20% | starch 50% | starch 20% | starch 50% | starch 20% |
| | | | | | Wheat flour 20% |
| (1) Crispy feeling of coating | 4.8 | 4.8 | 4.3 | 4.3 | 4.5 |
| (2) Lightness of mouthfeel of | 4.5 | 3.8 | 4.3 | 4.0 | 4.0 |
| coating | | | | | |
| (3) Stringing of coating | 4.3 | 4.0 | 4.0 | 3.3 | 4.3 |
| (4) Greasiness of coating | 4.3 | 4.0 | 4.0 | 3.0 | 4.3 |
| (5) Moist feeling of fillings | 4.0 | 3.3 | 4.0 | 3.0 | 4.0 |
| (meat) | | | | | |

From Table 5A and Table 5B, even in a case in which composition 1 and modified starches of tapioca starch were used in combination and in a case in which composition 1, a modified starch of tapioca starch, and wheat flour were used in combination, the crispy feeling of the coating, lightness of the mouthfeel of the coating, and the moist feeling of the fillings (meat) after storage in hot showcase could be enhanced, also, stringing and greasiness of the coating could be suppressed, compared to Comparative Example 1.

### Examples 19 to 23 and Comparative Example 2

Breader mixes of the compositions shown in Table 6A and Table 6B were produced using the powdery breaders of compositions 2 to 7 and wheat flour, and these were used as breader samples.

The evaluation results obtained before storage and after storage in hot showcase for karaages thus obtained are presented in Table 6A and Table 6B, respectively.

### Table 6

TABLE 6A
Before storage in hot showcase

| | Example 19 | Example 20 | Example 21 | Example 22 | | | |
|---|---|---|---|---|---|---|---|
| | Composition | Composition | Composition | Composition | | | Comparative |
| | 2 80% | 3 80% | 4 80% | 5 80% | Example 2 | Example 23 | Example 2 |
| | Wheat | Wheat | Wheat | Wheat | Composition 1 80% | Composition 6 80% | Composition 7 80% |
| Breader mix | flour 20% | flour 20% | flour 20% | flour 20% | Wheat flour 20% | Wheat flour 20% | Wheat flour 20% |
| (1) Crispy feeling | 5.0 | 5.0 | 4.8 | 4.8 | 4.8 | 4.3 | 3.5 |
| of coating | | | | | | | |
| (2) Lightness of mouthfeel | 3.8 | 4.0 | 5.0 | 5.0 | 4.8 | 5.0 | 3.8 |
| of coating | | | | | | | |
| (3) Stringing of coating | 4.3 | 5.0 | 5.0 | 5.0 | 4.8 | 4.5 | 4.5 |
| (4) Greasiness | 4.5 | 4.5 | 4.5 | 4.3 | 4.3 | 4.3 | 4.3 |
| of coating | | | | | | | |
| (5) Moist feeling of | 3.5 | 3.5 | 4.3 | 4.3 | 4.0 | 4.3 | 4.3 |
| fillings (meat) | | | | | | | |
| (6) Attachability of | 3 | 4 | 4 | 4 | 4 | 5 | 5 |
| coating to meat | | | | | | | |
| (7) Separation of | 3 | 4 | 4 | 4 | 4 | 5 | 5 |
| coating during | | | | | | | |
| deep-frying | | | | | | | |

TABLE 6B
After storage in hot showcase

| | Example 19 | Example 20 | Example 21 | | | | |
|---|---|---|---|---|---|---|---|
| | Composition | Composition | Composition | | | | Comparative |
| | 2 80% | 3 80% | 4 80% | Example 22 | Example 2 | Example 23 | Example 2 |
| | Wheat | Wheat | Wheat | Composition 5 80% | Composition 1 80% | Composition 6 80% | Composition 7 80% |
| Breader mix | flour 20% | flour 20% | flour 20% | Wheat flour 20% | Wheat flour 20% | Wheat flour 20% | Wheat flour 20% |
| (1) Crispy feeling of | 4.5 | 4.3 | 4.5 | 4.3 | 4.5 | 3.5 | 2.5 |
| coating | | | | | | | |
| (2) Lightness of | 3.3 | 4.0 | 4.3 | 4.5 | 4.3 | 4.3 | 3.0 |
| mouthfeel of | | | | | | | |
| coating | | | | | | | |
| (3) Stringing of | 3.3 | 4.0 | 4.0 | 5.0 | 4.0 | 4.0 | 3.3 |
| coating | | | | | | | |
| (4) Greasiness | 4.3 | 4.3 | 4.0 | 4.3 | 4.3 | 3.8 | 3.8 |
| of coating | | | | | | | |
| (5) Moist feeling | 3.0 | 3.3 | 3.8 | 4.0 | 4.0 | 3.5 | 3.3 |
| of fillings (meat) | | | | | | | |

From Table 6A and Table 6B, in Examples 19 to 23 in which compositions 2 to 6 were used, the crispy feeling of the coating after storage in hot showcase could be enhanced, compared to Comparative Example 2 in which composition 7 was used. The karaages obtained in Examples 19 to 23 had excellent lightness of the mouthfeel of the coating and excellent moist feeling of the fillings (meat) after storage in hot showcase, and showed suppressed stringing and greasiness of the coating.

### Examples 24 to 27

A test was performed according to Example 2, by using the breader sample of the composition of Example 2 (composition 1:wheat flour=80% by mass:20% by mass) and changing the deep-frying temperature and the deep-frying time. The deep-frying conditions are shown in Table 7A and Table 7B.

The evaluation results obtained before storage and after storage in hot showcase for the karaages thus obtained are presented in Table 7A and Table 7B, respectively.

### Table 7

TABLE 7A
Before storage in hot showcase

| | Example 24 | Example 25 | Example 26 | Example 27 |
|---|---|---|---|---|
| Deep-frying conditions | 170° C. | 180° C. | 190° C. | 190° C. |
| | 5 minutes | 4 minutes | 3 minutes | 5 minutes |
| (1) Crispy feeling of coating | 4.8 | 4.8 | 4.8 | 5.0 |
| (2) Lightness of mouthfeel of | 4.8 | 4.8 | 5.0 | 4.8 |
| coating | | | | |
| (3) Stringing of coating | 4.8 | 5.0 | 5.0 | 5.0 |
| (4) Greasiness of coating | 4.3 | 4.3 | 4.0 | 4.0 |
| (5) Moist feeling of fillings | 4.0 | 4.0 | 3.8 | 3.3 |
| (meat) | | | | |
| (6) Attachability of coating to | 4 | 4 | 4 | 4 |
| meat | | | | |
| (7) Separation of coating during | 4 | 4 | 4 | 4 |
| deep-frying | | | | |

TABLE 7B
After storage in hot showcase

| | Example 24 | Example 25 | Example 26 | Example 27 |
|---|---|---|---|---|
| Deep-frying conditions | 170° C. | 180° C. | 190° C. | 190° C. |
| | 5 minutes | 4 minutes | 3 minutes | 5 minutes |
| (1) Crispy feeling of coating | 4.5 | 4.0 | 4.3 | 5.0 |
| (2) Lightness of mouthfeel of | 4.3 | 3.8 | 4.0 | 3.5 |
| coating | | | | |
| (3) Stringing of coating | 4.0 | 4.0 | 3.8 | 4.0 |
| (4) Greasiness of coating | 4.3 | 4.0 | 4.3 | 4.0 |
| (5) Moist feeling of fillings | 4.0 | 3.8 | 3.8 | 3.0 |
| (meat) | | | | |

From Table 7A and Table 7B, even under different deep-frying conditions, the crispy feeling of the coating, lightness of the mouthfeel of the coating, and the moist feeling of the fillings (meat) after storage in hot showcase could be enhanced, also, stringing and greasiness of the coating could be suppressed, compared to Comparative Example 1. In view of the crispy feeling, cooking at 190° C. for 5 minutes was more preferred, and in view of the moist feeling, cooking at 170° C. for 5 minutes was more preferred.

### Example 28 and Comparative Example 3

In the present Example, composition 1 was incorporated into the batter, and karaages were produced by the following method.

That is, peeled chicken legs were cut into pieces each weighing 20 g. 4 parts by weight of soy sauce, 4 parts by weight of cooking sake, and 2 parts by weight of mirin were rubbed well onto 100 parts by weight of this chicken leg meat, and then the meat was soaked therein for 30 minutes at 4° C. in a refrigerator. Thus, the chicken leg meat was preliminarily seasoned.

Next, 11.4 parts by weight of each of the batter samples of the compositions shown in Table 8A and Table 8B, 0.09 parts by weight of a polysaccharide thickener, 0.06 parts by weight of paprika powder, and 18.45 parts by weight of water were mixed, and the mixture was carefully mixed until no lumps were left. Thus, a batter liquid was produced. This batter liquid was added to the preliminarily seasoned meat, and the meat was marinated well. Thus, battered meat was obtained.

Next, the breader sample of each Example was thinly dispersed in a container of an appropriate size, and the battered meat was rolled over the breader sample. Thus, the breader sample was uniformly attached to the meat, and breaded meat was obtained. Then, the breaded meat was deep-fried in canola oil at about 170° C. for 5 minutes, and then oil was drained off well. The deep-fried meat was transferred into a metal bat and was left to cool at room temperature for about 15 minutes.

The karaages thus obtained were evaluated by the methods described above. The evaluation results obtained before storage and after storage in hot showcase are presented in Table 8A and Table 8B, respectively. In Table 8A and Table 8B, the results of Example 2 and Comparative Example 1 shown in Table 2A and Table 2B are presented together.

### Table 8

TABLE 8A
Before storage in hot showcase

| | Comparative Example 1 | Example 2 | Comparative Example 3 | Example 28 |
|---|---|---|---|---|
| Batter sample | Wheat flour 100% | Wheat flour 100% | Composition 1 50% | Composition 1 50% |
| | | | Wheat flour 50% | Wheat flour 50% |
| Breader mix | Wheat flour 100% | Composition 1 80% | Wheat flour 100% | Composition 1 80% |
| | | Wheat flour 20% | | Wheat flour 20% |
| (1) Crispy feeling of coating | 3.5 | 4.8 | 4.3 | 5.0 |
| (2) Lightness of mouthfeel of | 3.5 | 4.8 | 4.5 | 5.0 |
| coating | | | | |
| (3) Stringing of coating | 4.0 | 4.8 | 4.3 | 4.5 |
| (4) Greasiness of coating | 3.5 | 4.3 | 4.0 | 4.3 |
| (5) Moist feeling of fillings | 3.3 | 4.0 | 4.0 | 4.0 |
| (meat) | | | | |
| (6) Attachability of coating to | 4 | 4 | 4 | 3 |
| meat | | | | |
| (7) Separation of coating during | 4 | 4 | 4 | 3 |
| deep-frying | | | | |

TABLE 8B
After storage in hot showcase

| | Comparative Example 1 | Example 2 | Comparative Example 3 | Example 28 |
|---|---|---|---|---|
| Batter sample | Wheat flour 100% | Wheat flour 100% | Composition 1 50% | Composition 1 50% |
| | | | Wheat flour 50% | Wheat flour 50% |
| Breader mix | Wheat flour 100% | Composition 1 80% | Wheat flour 100% | Composition 1 80% |
| | | Wheat flour 20% | | Wheat flour 20% |
| (1) Crispy feeling of coating | 2.3 | 4.5 | 3.0 | 4.8 |
| (2) Lightness of mouthfeel of | 2.5 | 4.3 | 3.5 | 4.8 |
| coating | | | | |
| (3) Stringing of coating | 1.8 | 4.0 | 2.8 | 4.5 |
| (4) Greasiness of coating | 2.8 | 4.3 | 3.3 | 4.3 |
| (5) Moist feeling of fillings | 2.3 | 4.0 | 3.5 | 4.0 |
| (meat) | | | | |

From Table 8A and Table 8B, compared to Comparative Example 3 in which composition 1 was used only in the batter sample, in Example 28 in which composition 1 was used in the breader sample as well, the crispy feeling of the coating, lightness of the mouthfeel of the coating, and the moist feeling of the fillings (meat) after storage in hot showcase could be enhanced, also, stringing and greasiness of the coating could be suppressed.

### Example 29

In this Example, non-fried food products (karaage-like food products) were produced by the following method, using the powdery breader of composition 1 in the coating material. The composition of the coating material is shown in Table 9.

TABLE 9
Composition of coating material

| | Composition |
|---|---|
| Material | (parts by mass) |
| Composition 1 | 30 |
| Breadcrumbs | 20 |
| Crosslinked tapioca starch | 20 |
| Gelatinized cornstarch | 5 |
| White sesame | 15 |
| Table salt | 5 |
| Amino acid seasoning | 5 |
| White pepper | 1 |
| Garlic powder | 1 |

Ten pieces of chicken leg meat cut into pieces each weighing 20 g were put in a plastic bag, and 30 g of the coating material of the composition shown in Table 9 was added thereto. The mixture was mixed well by shaking, and thus the coating material was uniformly attached to the meat.

A large tablespoon (15 mL) of canola oil was applied on a hot plate, and the meat attached with the coating material was placed thereon. The meat was heated and cooked for 5 minutes under dry-heating conditions at 220° C. in a convection oven (manufactured by Maruzen Co., Ltd.: SSC-03).

The coating of the non-fried food obtained in this manner was finished with a crisp light mouthfeel. Furthermore, even after storage for 6 hours in hot showcase and storage for 6 hours at 25°, the crisp mouthfeel was maintained, and the mouthfeel was satisfactory.

### Example 30

In this Example, a karaage to be subjected to frozen storage after being heated and cooked were produced and evaluated.

Specifically, karaage was produced according to Example 2, using the breader sample of the composition of Example 2 (composition 1:wheat flour=80% by mass:20% by mass). Furthermore, karaage was similarly produced using the breader sample of the composition of Comparative Example 1 (wheat flour 100% by mass).

The karaages that had been left to cool after deep-frying in oil were refrigerated overnight in a deep freezer at −40° C. Subsequently, karaages were transferred into a freezer at −20° C. and were stored in a frozen state for 7 days.

The karaages that had been stored in a frozen state were placed on a heat-resistant dish and were re-heated in a 500-W microwave oven for 2.5 minutes per four pieces.

The coating of the karaages thus obtained was finished with a crunchy crisp mouthfeel compared to the case of using wheat flour as the breader sample. Stringing caused by moisture absorption and softening of the coating was not felt, and the mouthfeel was satisfactory.

### Example 31

In this Example, production and evaluation of pork cutlets were performed.

Fats were removed from a log of pork loin in a frozen state, and the pork loin was cut into a thickness of 1.5 cm. 180 parts by weight of oil or fat-processed tapioca starch, 18 parts by weight of cornstarch, and 2 parts by weight of a polysaccharide thickener were mixed in a powdery state, and 380 parts by weight of cold water was added thereto. The mixture was dispersed until no lumps were left, and thus a batter liquid was produced.

The cut pork loin was battered by dipping the meat in the batter liquid.

Subsequently, the cut pork loin was dredged with a breader mix of the composition shown in Table 10 and was deep-fried in canola oil at 170° C. for 5 minutes. Regarding the breadcrumbs in the breader mix, breadcrumbs having the particle size adjusted with the JIS Z8801-1 standard sieves such that the content of particles that passed through a mesh with openings of 1.4 mm and were retained on a mesh with openings of 0.5 mm was 100% by mass, were used.

TABLE 10
Composition of breader mix

| | | Composition |
|---|---|---|
| Material | | (parts by weight) |
| Breader | Breadcrumbs | 10 |
| mix | Composition 4 | 10 |

The coating of the pork cutlets thus obtained had a crunchy and light mouthfeel, and even after a lapse of 6 hours at 25° C., sogginess was suppressed. Thus, the mouthfeel was satisfactory.

### Example 32

In the present Example, production and evaluation of deep-fried prawns were performed.

Black tiger prawns, having a shell and a back vein removed, were soaked in a pickling liquid obtained by dissolving 1 part by weight of table salt, 1.5 parts by weight of an amino acid seasoning, and 0.5 parts by weight of sodium tripolyphosphate in 97 parts by weight of cold water, for one hour at 4° C.

Furthermore, 6.5 parts by weight of table salt, 0.5 parts by weight of white pepper, 2 parts by weight of an amino acid seasoning, 15 parts by weight of corn flour, 66 parts by weight of oil or fat-processed tapioca starch, and 216 parts by weight of cold water were mixed until no lumps were left, and thus a batter liquid was produced. The black tiger prawns after soaking were battered by dipping the prawns in the batter liquid.

After battering, the prawns were dredged with the breader mix of the composition shown in Table 10 and were deep-fried in canola oil at 170° C. for 3 minutes.

The coating of the deep-fried prawns obtained in this manner was finished with a crisp light mouthfeel, and even after storage in hot showcase for 6 hours and storage at 25° C. for 6 hours, the crisp mouthfeel was maintained.

This patent application claims priority based on Japanese Patent Application No. 2016-091707 filed on Apr. 28, 2016, the entire disclosure of which is incorporated herein by reference.

1. A method for achieving, when a deep-fried (-like) food product is stored in hot showcase, stored at room temperature, stored in a chilled state, stored in a frozen state, or cooked in a microwave oven, suppression of stringing of a coating of the deep-fried (-like) food product, maintenance of a crisp light mouthfeel, and suppression of deterioration of the mouthfeel of fillings,
the method comprising:
attaching a coating material including a powdery breader to an outer side of the fillings,
wherein the powdery breader includes starch at a proportion of 75% by mass or more and 100% by mass or less,
wherein the powdery breader includes, as the starch, a lowered molecular weight starch having an amylose content of 5% by mass or more and a peak molecular weight of 3×10³ or more and 5×10⁴ or less, at a proportion of 3% by mass or more and 45% by mass or less with respect to the total amount of the powdery breader, and
wherein a content of oversized particles retained on a sieve with openings of 0.1 mm in the powdery breader is 20% by mass or more and 100% by mass or less.

2. The method according to claim 1, wherein a degree of swelling in cold water at 25° C. of the powdery breader is 7 or higher and 20 or lower.

3. The method according to claim 1, wherein the lowered molecular weight starch is a lowered molecular weight high-amylose cornstarch.

4. The method according to claim 1, wherein the content of oversized particles retained on a sieve with openings of 0.5 mm in the powdery breader is 10% by mass or more and 100% by mass or less.

5. The method according to claim 1, wherein the powdery breader includes cornstarch as the starch other than the lowered molecular weight starch.

6. The method according to claim 1, wherein the coating material is a breader mix comprising the powdery breader.

7. The method according to claim 6, wherein a content of the powdery breader in the breader mix is 20% by mass or more and 100% by mass or less with respect to the total amount of the breader mix.

8. The method according to claim 6, wherein the breader mix further includes one kind or two or more kinds selected from the group consisting of wheat flour, breadcrumbs, and a starch other than the powdery breader.

9-13. (canceled)

14. The method according to claim 1,
wherein the coating material is a breader mix including the powdery breader, and
wherein the method further includes heating and cooking the fillings having the breader mix attached thereto, and thereby obtaining deep-fried (-like) food products.

15. A method for enhancing a moist feeling of fillings of a deep-fried (-like) food product when the deep-fried (-like) food product is stored in hot showcase, stored at room temperature, stored in a chilled state, stored in a frozen state, or cooked in a microwave oven,
the method comprising:
attaching a coating material including a powdery breader to an outer side of the fillings,
wherein the powdery breader includes starch at a proportion of 75% by mass or more and 100% by mass or less,
wherein the powdery breader includes, as the starch, a lowered molecular weight starch having an amylose content of 5% by mass or more and a peak molecular weight of 3×10³ or more and 5×10⁴ or less, at a proportion of 3% by mass or more and 45% by mass or less with respect to the total amount of the powdery breader, and
wherein a content of oversized particles retained on a sieve with openings of 0.1 mm in the powdery breader is 20% by mass or more and 100% by mass or less.

16. A method for suppressing greasiness of a coating of a deep-fried (-like) food product when the deep-fried (-like) food product is stored in hot showcase, stored at room temperature, stored in a chilled state, stored in a frozen state, or cooked in a microwave oven,
the method comprising:
attaching a coating material including a powdery breader to an outer side of fillings,
wherein the powdery breader includes starch at a proportion of 75% by mass or more and 100% by mass or less,
wherein the powdery breader includes, as the starch, a lowered molecular weight starch having an amylose content of 5% by mass or more and a peak molecular weight of 3×10³ or more and 5×10⁴ or less, at a proportion of 3% by mass or more and 45% by mass or less with respect to the total amount of the powdery breader, and
wherein a content of oversized particles retained on a sieve with openings of 0.1 mm in the powdery breader is 20% by mass or more and 100% by mass or less.
